(19) United States
(12) Patent Application Publication
(10) Pub. No.: US 2009/0111377 A1
(43) Pub. Date: Apr. 30, 2009

(54) FREQUENCY CONVERTER AND RECEIVER AND TRANSMITTER USING THE SAME

(75) Inventors: Toshiya Mitomo, Kawagoe-shi (JP); Rui Ito, Chigasaki-shi (JP); Shoji Otaka, Yokohama-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/234,730

(22) Filed: Sep. 22, 2008

(30) Foreign Application Priority Data
Oct. 29, 2007 (JP) 2007-280767

(51) Int. Cl. H04B 7/14

(52) U.S. Cl. 455/20

(57) ABSTRACT

A frequency converter includes a voltage-current converter circuit which generates a positive-phase input current signal and a negative-phase input current signal, a switching circuit which switches between the positive-phase input current signal and the negative-phase input current signal according to a positive-phase local oscillator signal and a negative-phase local oscillator signal to generate a positive-phase output current signal and a negative-phase output current signal, an amplifier circuit which current-voltage converts and amplifies the positive-phase output current signal and negative-phase output current signal to generate a positive-phase output voltage signal and a negative-phase output voltage signal, and a plurality of CR circuits which are inserted at least either between the voltage-current converter circuit and the switching circuit or between the switching circuit and the amplifier circuit and each of which includes at least one capacitor through which high-frequency components pass and at least one resistance through which low-frequency noise components pass.

### CROSS-REFERENCE TO RELATED APPLICATIONS

This application is based upon and claims the benefit of priority from prior Japanese Patent Application No. 2007-280767, filed Oct. 29, 2007, the entire contents of which are incorporated herein by reference.

### BACKGROUND OF THE INVENTION

1. Field of the Invention

This invention relates to an RF signal frequency converter and to a receiver and a transmitter which use the same.

2. Description of the Related Art

A wireless terminal, which receives or transmits a radio-frequency (RF) signal, uses a frequency converter. For example, a receiver uses a down-converter to mix a received RF signal and a local oscillator (LO) signal to generate a received baseband signal. A transmitter uses an up-converter to mix a transmitting baseband signal and an LO signal to generate a transmitting RF signal.

A complementary metal-oxide semiconductor (CMOS) frequency converter can be realized using an integrated circuit (IC) produced by the same CMOS process as a baseband processing unit. The baseband processing unit processes the received baseband signal and the transmitting baseband signal. Accordingly, this makes it possible to squeeze an analog signal processing unit and a digital signal processing unit into one chip. Integrating the two units into one chip enables a wireless terminal to be made more compact and less expensive.

It is well known that a CMOS frequency converter using an active double-balance CMOS mixer generates relatively large low-frequency flicker noise (1/f noise) because a large current flows through the switching transistor pair in the CMOS mixer. A CMOS frequency converter using a passive double-balance CMOS mixer can solve the flicker noise problem.

When a CMOS frequency converter using a passive double-balance CMOS mixer is used in a receiver, an input stage for voltage-current converting a received differential RF signal is provided in the preceding stage of the CMOS mixer and an amplifier (output) stage, such as a current-to-voltage conversion amplifier, in a subsequent stage. The CMOS mixer includes a MOS transistor pair (switching transistor pair) which receives a differential LO signal at its gate and performs a complementary on/off operation repeatedly. Actually, it is difficult to perform a completely complementary on/off operation of the switching transistor pair and therefore there may be a case where both the transistors turn on at the same time transiently. If both the transistors are turned on, the input conversion noise in the amplifier stage is input via the transistors (or via the on-resistances of both the transistors as the input resistance) to the amplifier stage, which amplifies the noise. Specifically, the amplifier stage is an operational amplifier with feedback resistance Rf. If the on-resistance of each of the transistors of the transistor pair is Rs, noise is multiplied by Rf/2Rs (noise gain) by the amplifier stage. Since the resistance Rf of the feedback resistance is greater than the resistance Rs of the on-resistance of the MOS transistor, the noise gain Rf/2Rs is very large.

Paulo G. R. Silva, et al., “An 118 dB DR CT IF-to-Baseband τΔ Modulator for AM/FM/IBOC Radio Receivers, “IEEE International Solid-State Circuits Conference, February 2006 (hereinafter, simply referred to as the related art) has disclosed a configuration where a resistance pair with a resistance of Rin is inserted in the input stage side (drain side) of the switching transistor pair. Although the configuration is not designed to reduce the noise gain, the input resistance of the aforementioned noise source is actually increased by the resistance pair and the input resistance reaches 2(Rs+Rin), with the result that the noise gain decreases to Rf/2(Rs+Rin).

In the configuration disclosed in the related art, unless an increment Rin in the resistance viewed from the input stage side is sufficiently smaller than the output resistance (impedance) of the current source included in the input stage, current generated at the current source is shunted to the output resistance, degrading the signal gain. As described above, if the amplifier stage is an operational amplifier having a feedback resistance with a resistance of Rf, the resistance Rf is frequently about several kΩ and the resistance Rin is almost the same resistance. Since the output resistance of the current source in the input stage is about several hundred Ω at most, the shunt current cannot be avoided, reducing the signal gain. Moreover, since a resistance has been inserted in the input stage side of the switching transistor pair, the impedance difference between the input stage side and the amplifier stage side (source side) is large. In this case, the local oscillator signal input to the gate of the switching transistor and a drain current generated by the parasitic capacitance of the transistor increase, which causes the problem of increasing flicker noise.

### BRIEF SUMMARY OF THE INVENTION

According to an aspect of the invention, there is provided a frequency converter comprising: a voltage-current converter circuit which converts a positive-phase input voltage signal and a negative-phase input voltage signal into a positive-phase input current signal and a negative-phase input current signal, respectively; a switching circuit which switches between the positive-phase input current signal and the negative-phase input current signal according to a positive-phase local oscillator signal and a negative-phase local oscillator signal to generate a positive-phase output current signal and a negative-phase output current signal; an amplifier circuit which current-voltage converts and amplifies the positive-phase output current signal and negative-phase output current signal to generate a positive-phase output voltage signal and a negative-phase output voltage signal; and a plurality of CR circuits which are inserted at least either between the voltage-current converter circuit and the switching circuit or between the switching circuit and the amplifier circuit and each of which includes at least one capacitor through which high-frequency components pass and at least one resistance through which low-frequency noise components pass.

According to another aspect of the invention, there is provided a frequency converter comprising: a voltage-current converter circuit which converts a positive-phase input voltage signal and a negative-phase input voltage signal into a positive-phase input current signal and a negative-phase input current signal, respectively; a switching circuit which switches between the positive-phase input current signal and the negative-phase input current signal according to a positive-phase local oscillator signal and a negative-phase local oscillator signal to generate a positive-phase output current signal and a negative-phase output current signal; an amplifier circuit which current-voltage converts and amplifies the positive-phase output current signal and negative-phase output current signal to generate a positive-phase output voltage signal and a negative-phase output voltage signal; and two resistances which are provided in front of the amplifier circuit and through which the positive-phase output current signal or the negative-phase output current signal passes, respectively.

### BRIEF DESCRIPTION OF THE SEVERAL VIEWS OF THE DRAWING

FIG. 1 is a block diagram of a CMOS frequency converter according to a first embodiment;

FIG. 2 is a circuit diagram of the CMOS frequency converter of FIG. 1;

FIG. 3 is a circuit diagram of a concrete circuit of the input stage in FIG. 1;

FIG. 4 is a circuit diagram of a concrete circuit of the amplifier stage in FIG. 1;

FIG. 5 is a circuit diagram of a CMOS frequency converter according to a second embodiment;

FIG. 6 is a circuit diagram of a CMOS frequency converter according to a third embodiment;

FIG. 7 is a circuit diagram of a CMOS frequency converter according to a fourth embodiment;

FIG. 8 is a block diagram of a receiver according to a fifth embodiment; and

FIG. 9 is a block diagram of a transmitter according to a sixth embodiment.

### DETAILED DESCRIPTION OF THE INVENTION

Hereinafter, referring to the accompanying drawings, embodiments of the invention will be explained.

### First Embodiment

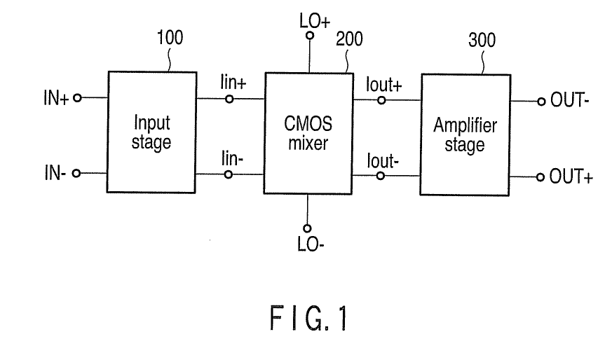

As shown in FIG. 1, a CMOS frequency converter according to a first embodiment of the invention comprises an input stage 100, a CMOS mixer 200, and an amplifier stage 300. The input stage 100 generates a differential input current signal Iin by voltage-current converting a differential input voltage signal IN. The CMOS mixer 200 generates a differential output current signal Iout by combining the differential input current signal Iin and a differential local oscillator signal LO. The amplifier stage 300 generates a differential output voltage signal OUT by amplifying the differential output current signal Iout. Hereinafter, an explanation will be given about a case where the CMOS frequency converter of the first embodiment is used for down-conversion. The CMOS frequency converter may be used for up-conversion.

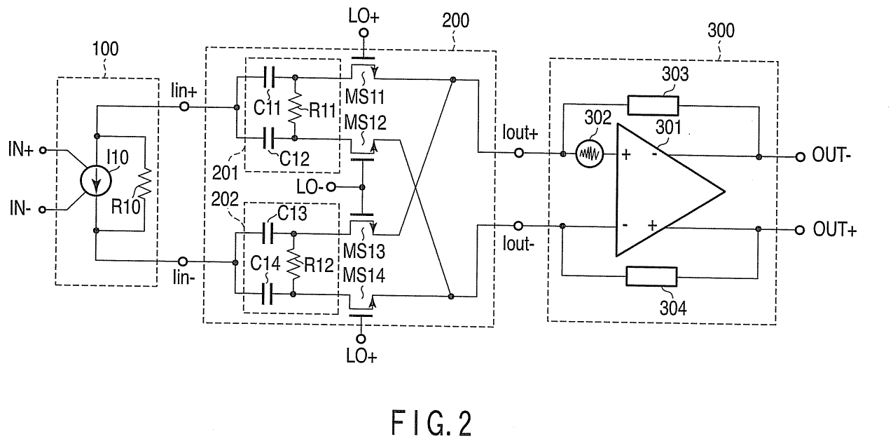

As shown in FIG. 2, the input stage 100 includes a (voltage controlled) current source 110 which generates a current according to the voltage of the differential input voltage signal IN (or the voltage difference between a positive-phase input voltage signal IN+ and a negative-phase input voltage signal IN−). A resistance R10 represents the output impedance of the current source 110 equivalently. Resistance R10 actually is not connected. The current generated by the current source 110 is used as a differential input current signal Iin to the CMOS mixer 200. Generally, to eliminate the direct-current components from the differential input current signal Iin, a capacitor is provided on the output side of the input stage 100. In the CMOS frequency converter of the first embodiment, however, CR circuits 201 and 202 in the CMOS mixer 200 eliminate the direct-current components included in the differential input current signal Iin as described later. Accordingly, as shown in FIG. 2, there is no need to provide a capacitor for eliminating the direct-current components in the input stage 100 of the first embodiment.

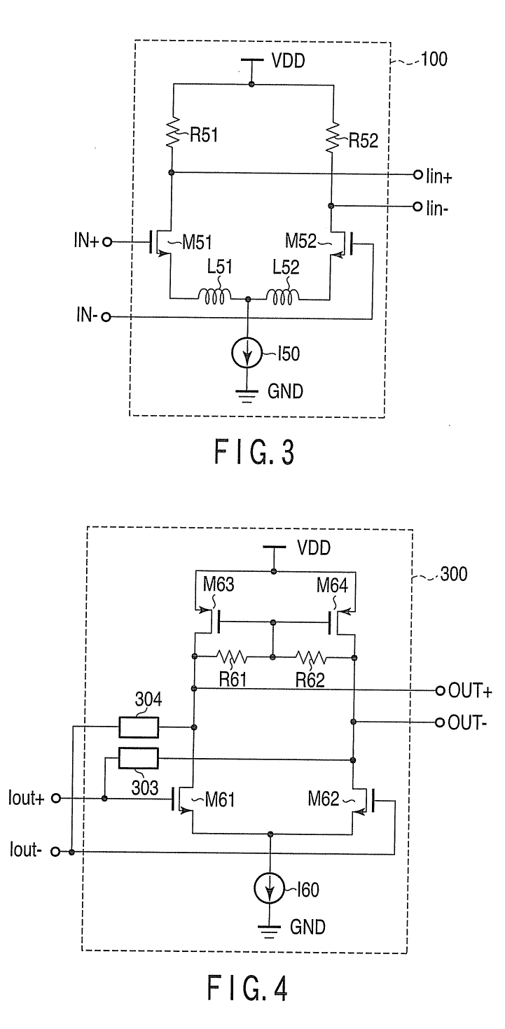

Moreover, as shown in FIG. 3, a concrete example of the input stage 100 includes MOS transistors M51 and M52, a current source 150, load resistances R51 and R52, and feedback inductors L51 and L52.

MOS transistor M51 receives the positive-phase input voltage signal IN+ at its gate and outputs a positive-phase input current signal Iin+ at its drain. MOS transistor M52 receives the negative-phase input voltage signal IN− at its gate and outputs a negative-phase input current signal Iin− at its drain. The load resistances R51 and R52 are connected between a power supply and the drains of MOS transistors M51 and M52, respectively. The resistance values of the load resistances R51 and R52 are such that they are sufficiently higher than the on-resistance of a switching transistor described later and provide an operating point at which MOS transistors M51, M52 can operate.

The sources of MOS transistors M51 and M52 are connected via feedback inductors L51 and L52, respectively, to the current source 150 in a common connection manner. The current source 150 is a tail current source which performs control so that the sum of the drain currents in MOS transistors M51 and M52 may be constant.

As shown in FIG. 2, the CMOS mixer 200, which is a passive double-balance CMOS mixer, includes CR circuits 201 and 202 which are provided in front of two switching transistor pairs MS11-MS12 and MS13-MS14, respectively, and whose signal path is selected according to the signal frequency. The switching transistor pairs MS11-MS12 and MS13-MS14 perform a complementary on/off operation repeatedly according to a differential LO signal supplied to the gates. Specifically, when MOS transistors MS11 and MS14 are on, MOS transistors MS12 and MS13 are off. When MOS transistors MS11 and MS14 are off, MOS transistors MS12 and MS13 are on. When MOS transistors MS11 and MS14 are on, the drain current of MOS transistor MS11 is input as a positive-phase output current signal Iout+ to the amplifier stage 300 and the drain current of MOS transistor MS14 is input as a negative-phase output current signal Iout− to the amplifier stage 300. When MOS transistors MS12 and MS13 are on, the drain current of MOS transistor MS13 is input as a positive-phase output current signal Iout+ to the amplifier stage 300 and the drain current of MOS transistor MS12 is input as a negative-phase output current signal Iout− to the amplifier stage 300.

Since the configuration of the CR circuit 202 is the same as that of the CR circuit 201, hereinafter, only the CR circuit 201 will be explained. In the explanation below, the CR circuit 202 will be understood by reading the reference numerals as the corresponding ones and the positive phase as the negative one.

The CR circuit 201 includes a resistance R11 and capacitors C11 and C12. Capacitors C11 and C12 receive the positive-phase input current signal Iin+ from the input stage 100 in parallel and input the current signal Iin+ to the switching transistor pair MS11 and MS12, respectively. It is desirable that the capacitances of capacitors C11 and C12 should be the same. In the explanation below, let the capacitance of each of them be C. Resistance R11 connects a node between capacitor C11 and MOS transistor MS11 and a node between capacitor C12 and MOS transistor MS12.

The positive-phase input current signal Iin+ including the high frequency signal components from the input stage 100 and a noise signal including the low-frequency noise components from the input conversion noise source 302 of the amplifier stage 300 flow into the CR circuit 201. In the CR circuit 201, a signal path which passes through capacitor C11 and/or C12 is provided for the positive-phase input current signal Iin+ and a signal path which passes through resistance R11 is provided for noise signal. Specifically, the impedance of the capacitors C11 and C12 constituting the CR circuit 201 is sufficiently lower than the resistance R of resistance R11 at the RF frequency. That is, the positive-phase input current signal Iin+ obtained by voltage-current converting the differential input voltage signal IN in the RF frequency band mainly passes through capacitor C11 and/or C12 and is input to MS11 and/or MS12. At this time, the direct-current components of the positive-phase input current signal Iin+ have been eliminated by capacitor C11 and/or C12. In contrast, the frequency of the noise signal from the input conversion noise source 302 of the amplifier stage 300 is far lower than the RF frequency, increasing the impedance of the capacitors C11 and C12, which almost prevents the noise signal from passing through. Accordingly, the noise signal from the input conversion noise source 302 mainly passes through the following path: MS11→R11→MS12.

As shown in FIG. 2, the amplifier stage 300 is a feedback amplifier circuit where feedback elements 303 and 304 are connected to an operational amplifier 301. Hereinafter, the explanation will be given on the assumption that resistances whose resistance values are Rf are connected as the feedback elements 303 and 304. The embodiment is not limited to this. For instance, capacitors may be connected to constitute an integrator or other elements or circuits may be connected to constitute a filter. That is, as long as the amplifier stage 300 is a current-to-voltage conversion amplifier, it may take any configuration. Although the input conversion noise source 302 is represented equivalently by converting noise in the amplifier stage 300 into input noise, such a signal source actually is not connected to the operational amplifier 301.

Moreover, as shown in FIG. 4, a concrete configuration of the amplifier stage 300 includes MOS transistors M61 and M62, a current source 160, feedback elements 303 and 304, MOS transistors M63 and M64, and load resistances R61 and R62.

MOS transistor M61 receives the positive-phase output current signal Iout at its gate and outputs a positive-phase output voltage signal OUT+ at its drain. MOS transistor M62 receives the negative-phase output current signal Iout− at its gate and outputs a negative-phase output voltage signal OUT− at its drain. A load circuit composed of MOS transistors M63 and M64 and load resistances R61 and R62 is connected between a power supply and the drains of MOS transistors M61 and M62.

The feedback element 303 is connected between the gate of MOS transistor M61 and the drain of MOS transistor M62. The feedback element 304 is connected between the gate of MOS transistor M62 and the drain of MOS transistor M61. The sources of MOS transistors M61 and M62 are connected equally to the current source 160. The current source 160 is a tail current source which performs control so that the sum of the drain currents in MOS transistors M61 and M62 may be constant.

Hereinafter, the operation of the CMOS mixer 200 of FIG. 2 will be explained, centering on the signal path of the differential input current signal Iin from the input stage 100 and the noise signal from the input conversion noise source 302 in the amplifier stage 300.

The differential input current signal Iin passes through the CR circuits 201 and 202 and is input to the switching transistor pairs MS11-MS12 and MS13-M14, which output a differential output current signal Iout. In the CR circuits 201 and 202, the path through which the differential input current signal Iin passes and its impedance will be explained, using the CR circuit 201 as an example.

First, consider a case where the switching transistor pair MS11-MS12 operates complementarily and one transistor is on and the other is off. At this time, since no signal flows in the off MOS transistor, the positive-phase input current signal Iin+, which have passed through a path where a series connection of a capacitor and a resistance is connected with a capacitor in parallel, flows into the on MOS transistor. For example, if MOS transistor MS11 is on, the positive-phase input current signal Iin+, which has passed through a path where a series connection of a capacitor C12 and a resistance R11 is connected with a capacitor C11 in parallel, flows into the transistor MS11. The impedance of the path is expressed by the following equation (1):

$$\frac{1}{sC} \cdot \frac{1 + sCR}{2 + sCR} \qquad ( 1 )$$

Actually, since the positive-phase input current signal Iin+ is a signal in the RF frequency band, it follows that R>>1/sC. Since 1+sCR≈2+sCR in equation (1), the impedance is approximated by 1/sC. Thus, the positive-phase input current signal Iin+hardly passes through resistance R11 and most of the signal Iin+ passes through capacitor C11 and is input to MOS transistor MS11.

Accordingly, in the CR circuit 201, the impedance of the path through which the positive-phase input current signal Iin+ passes is sufficiently lower than the output impedance R10 of the current source 110. Therefore, a signal current shut problem found in the related art does not arise, which enables most of the current generated by the current source 110 to be input as the positive-phase input current signal Iin+ to the switching transistor pair MS11-MS12. That is, a decrease in the signal gain due to the signal current shunt is suppressed.

Furthermore, in the related art, large flicker noise was produced by the imbalance between the impedance on the input stage side viewed from the switching transistor pair and the impedance on the amplifier stage side due to the inserted resistance. As described above, in the CMOS frequency converter of FIG. 2, since the impedance 1/sC on the input stage 100 side of the switching transistor pair MS11-MS12 is much lower than resistance R11, the imbalance does not occur in the positive-phase input current signal Iin+, suppressing flicker noise.

When the switching transistor pair operates complementarily, a noise signal is not a problem. Thus, a case where both the transistors of the switching transistor pair are turned on transiently will be explained, centering on the signal path in the CR circuit 201 for a noise signal.

When a noise signal is input by MOS transistor MS11, passes through the CR circuit 201, and is output to MOS transistor MS12, two path candidates in the CR circuit 201 can be considered. They are a path passing through resistance R11 and a path passing through series-connected capacitors C11 and C12. However, as described above, since the noise signal has a low frequency, the impedance of the capacitors C11 and C12 increases and becomes higher than the resistance R of resistance R11. Therefore, the path passing through resistance R11 is selected. That is, the noise signal hardly flows through the path passing through the capacitors C11 and C12 and mainly flows through the path passing through resistance R11, which approximates the impedance of the path to R.

Accordingly, if the resistance value of the on-resistance of each of MOS transistors MS11 and MS12 is Rs, a noise signal is input to an operational amplifier 301 with an input resistance whose resistance value is R+2Rs. That is, the noise gain of the amplifier stage 300 is Rf/(R+2Rs). Generally, the resistance value Rs of the on-resistance is about several Ω, the resistance value Rf of each of the feedback elements 303 and 304 is about several kΩ, and the resistance value R of resistance R11 is almost the same as the resistance value Rf. Thus, the noise gain is not very large and can be reduced remarkably as compared with the noise gain Rf/2Rs in the conventional example.

As described above, the CMOS frequency converter of the first embodiment is such that the CR circuit which selects a signal path passing through a capacitor for a differential input current signal including the high-frequency signal components and a signal path passing through a resistance for a noise signal including the low-frequency noise components is provided in front of the switching transistor pair in the CMOS mixer. Accordingly, in the CMOS frequency converter of the first embodiment, since the differential input current signal can pass through the CR circuit in the low impedance path, not only is a decrease in the signal gain due to the current shunt in the input stage suppressed, but also an increase in flicker noise due to the imbalance between the impedances at the input and output of the switching transistor pair is suppressed. Moreover, when both the transistors of the switching transistor pair are turned on and a noise signal from the input conversion noise source of the amplifier stage passes through the CR circuit, since the path passing through the resistance is provided, the input resistance to the amplifier stage increases, which suppresses the noise gain. Moreover, in the CMOS frequency converter of the first embodiment, since the differential input current from the input stage is received by the capacitor in the CR circuit, there is no need to provide a direct-current component eliminating capacitor in the input stage.

### Second Embodiment

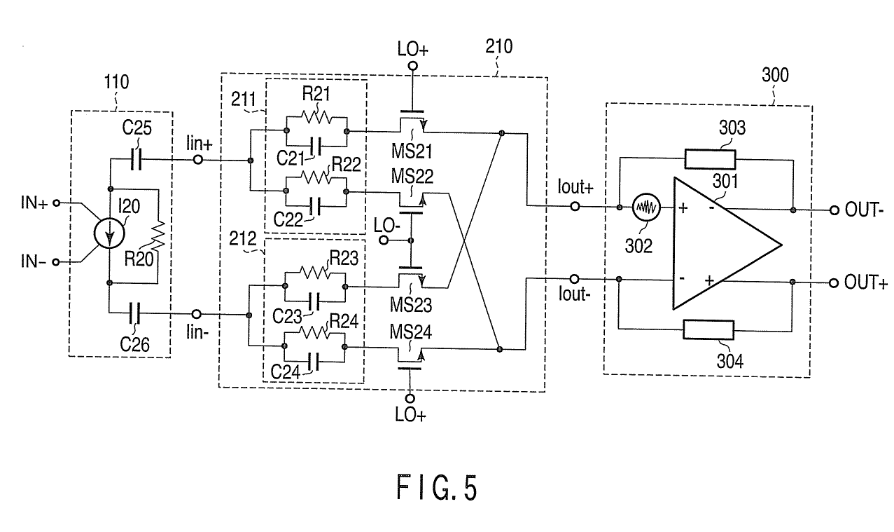

As shown in FIG. 5, a CMOS frequency converter according to a second embodiment of the invention is such that the input stage 100 is replaced with an input stage 110 and the CMOS mixer 200 is replaced with a CMOS mixer 210 in the CMOS frequency converter of FIG. 2. In FIG. 5, the same parts as those in FIG. 1 are indicated by the same reference numerals and an explanation will be given, centering on the difference between FIG. 5 and FIG. 1. A case where the CMOS frequency converter of the second embodiment is used for down-conversion will be explained. The CMOS frequency converter may be used for up-conversion.

In the COMS frequency converter of FIG. 5, the input stage 110 voltage-current converts a differential input voltage signal IN into a differential input current signal Iin. The CMOS mixer 210 combines the differential input current signal Iin with a differential local oscillator signal LO, thereby generating a differential output current signal Iout. The amplifier stage 300 amplifies the differential output current signal Iout, thereby generating a differential output voltage signal OUT.

As shown in FIG. 5, the input stage 110 includes a (voltage controlled) current source 120 which generates a current according to the voltage (the difference between the positive-phase input voltage signal IN+ and the negative-phase input voltage signal IN−) of the differential input voltage signal IN. A resistance R20 represents the output impedance of the current source 120 equivalently. Resistance R20 actually is not connected. The current generated by the current source 120 passes through direct-current-eliminating capacitors C25 and C26 and is used as a differential input current signal Iin to the CMOS mixer 210.

As shown in FIG. 5, the CMOS mixer 210, which is a passive double-balance CMOS mixer, includes CR circuits 211 and 212 each of whose signal paths is selected according to the signal frequency in front of two switching transistor pairs MS21-MS22 and MS23-MS24, respectively. The switching transistor pairs MS21-MS22 and MS23-MS24 perform a complementary on/off operation repeatedly according to a differential LO signal supplied to the gates. Specifically, when MOS transistors MS21 and MS24 are on, MOS transistors MS22 and MS23 are off. When MOS transistors MS21 and MS24 are off, MOS transistors MS22 and MS23 are on. When MOS transistors MS21 and MS24 are on, the drain current of MOS transistors MS21 is input as a positive-phase output current signal Iout+ to the amplifier stage 300 and the drain current of MOS transistor MS24 is input as a negative-phase output current signal Iout− to the amplifier stage 300. When MOS transistors MS22 and MS23 are ON, the drain current of MOS transistors MS23 is input as a positive-phase output current signal Iout+ to the amplifier stage 300 and the drain current of MOS transistor MS22 is input as a negative-phase output current signal Iout− to the amplifier stage 300.

Since the configuration of the CR circuit 212 is the same as that of the CR circuit 211, only the CR circuit 211 will be explained. In the explanation below, the CR circuit 212 will be understood by reading the reference numerals as the corresponding ones and the positive phase as the negative one.

The CR circuit 211 is a circuit where a parallel connection of a resistance R21 and a capacitor C21 and a parallel connection of a resistance R22 and a capacitor C22 receive the positive-phase input current signal Iin+ in parallel. It is desirable that the resistance value of resistance R21 should be equal to that of resistance R22 and the capacitance of capacitor C21 should be equal to that of capacitor C22. In the explanation below, let the resistance value of each of the resistances R21 and R22 be R and the capacitance of each of the capacitors C21 and C22 be C.

The positive-phase input current signal Iin+ including the high-frequency signal components from the input stage 110 and a noise signal including the low-frequency noise components from the input conversion noise source 302 of the amplifier stage 300 flow into the CR circuit 211. In the CR circuit 211, a signal path which passes through capacitor C21 and/or C22 is provided for the positive-phase input current signal Iin+ and a signal path which passes through resistances R21 and R22 is provided for noise signal. Specifically, the impedance of the capacitors C21 and C22 constituting the CR circuit 211 is sufficiently lower than the resistance value R of the resistances R21 and R22 at the RF frequency. That is, the positive-phase input current signal Iin+ obtained by voltage-current converting the differential input voltage signal IN in the RF frequency band passes through capacitor C21 and/or C22 and flows into MS21 and/or MS22. In contrast, the frequency of the noise signal from the input conversion noise source 302 of the amplifier stage 300 is far lower than the RF frequency, which increases the impedance of the capacitors C21 and C22, with the result that the noise signal hardly passes through. Accordingly, the noise signal from the input conversion noise source 302 mainly passes through the resistances R21 and R22.

Hereinafter, the operation of the CMOS mixer 210 of FIG. 5 will be explained, centering on the signal path of the differential input current signal Iin from the input stage 110 and that of the noise signal from the input conversion noise source 302 in the amplifier stage 300.

The differential input current signal Iin passes through the CR circuits 211 and 212 and is input to the switching transistor pairs MS21-MS22 and MS23-M24, which output a differential output current signal Iout. In the CR circuits 211 and 212, the path through which the differential input current signal Iin passes and its impedance will be explained, using the CR circuit 211 as an example.

Since the path through which the positive-phase input current signal Iin+ passes includes a parallel connection of a capacitor with the capacitance C and a resistance with the resistance value R, the impedance is expressed by the following equation (2):

$$\frac{R}{1 + sCR} \qquad ( 2 )$$

As described above, since the positive-phase input current signal Iin+ is a signal in the RF frequency band, it follows that 1+sCR≈sCR, and therefore the impedance is approximated by 1/sC. Thus, the positive-phase input current signal Iin+ hardly passes through the resistance and most of the signal Iin+ passes through the capacitor and is input to the MOS transistor.

In the CR circuit 211, the impedance (≈1/sC) of the path through which the positive-phase input current signal Iin+ passes is sufficiently lower than the output impedance R20 of the current source 120. Therefore, a signal current shunt problem found in the related art does not arise, which allows most of the current generated by the current source 120 to be input as the positive-phase input current signal Iin+ to the switching transistor pair MS21-MS22. That is, a decrease in the signal gain due to the signal current shunt is suppressed.

Furthermore, in the related art, large flicker noise was produced due to the imbalance between the impedance on the input stage side of the switching transistor pair and the impedance on the amplifier stage side. As described above, in the CMOS frequency converter of FIG. 5, since the impedance 1/sC on the input stage 100 side of the switching transistor pair MS11-MS12 is very low, the imbalance does not occur in the positive-phase input current signal Iin+, suppressing flicker noise.

When the switching transistor pair operates complementarily, a noise signal is not a problem. Therefore, a case where both the transistors of the switching transistor pair are turned on transiently will be explained, centering on the signal path in the CR circuit 211 for a noise signal.

In the CR circuit 211, a noise signal passes through a parallel connection of resistance R21 and capacitor C21 and then a parallel connection of resistance R22 and capacitor C22. Since the noise signal has a low frequency and the impedance of capacitor C25 increases, signal leakage to the input stage 110 side can be neglected. As described above, since the noise signal has a low frequency, the impedance of the capacitors C21 and C22 increases and becomes higher than the resistance value R of the resistances R21 and R22. Therefore, in the CR circuit 211, the path passing through the resistances R21 and R22 is selected. That is, the noise signal hardly flows through the path passing through the capacitors C21 and C22 and mainly flows through the path passing through the resistances R21 and R22, causing the impedance of the path to be approximated by 2R.

Accordingly, if the resistance value of each of the on-resistances of MOS transistors MS21 and MS22 is Rs, a noise signal is input to an operational amplifier 301 with an input resistance whose resistance value is 2R+2Rs. That is, the noise gain of the amplifier stage 300 is Rf/(2R+2Rs). Generally, the resistance value Rs of the on-resistance is about several Ω, the resistance value Rf of each of the feedback elements 303 and 304 is about several kΩ, and the resistance value R of each of the resistances R21 and R22 is almost the same as the resistance value Rf. Therefore, the noise gain is not very large and is reduced remarkably as compared with the noise gain Rf/2Rs in the conventional example.

As described above, the CMOS frequency converter of the second embodiment is such that the CR circuit which selects a signal path passing through a capacitor for a differential input current signal including the high-frequency signal components and a signal path passing through resistances for a noise signal including the low-frequency noise components is provided in front of the switching transistor pair in the CMOS mixer. Accordingly, in the CMOS frequency converter of the second embodiment, since the differential input current signal can pass through the CR circuit in a low impedance path, not only is a decrease in the signal gain due to the current shunt in the input stage suppressed, but also an increase in the flicker noise due to the imbalance between the impedances at the input and output of the switching transistor pair is suppressed. Moreover, when both the transistors of the switching transistor pair are turned on and a noise signal from the input conversion noise source in the amplifier stage passes through the CR circuit, since the path passing through the resistance is provided, the input resistance to the amplifier stage increases, which suppresses the noise gain.

### Third Embodiment

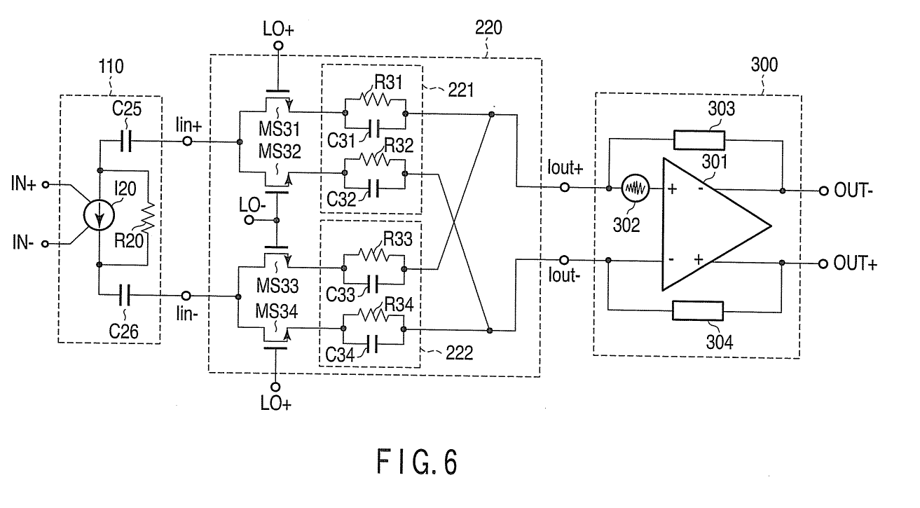

As shown in FIG. 6, a CMOS frequency converter according to a third embodiment of the invention is such that the CMOS mixer 210 is replaced with a CMOS mixer 220 in the CMOS frequency converter of FIG. 5. In FIG. 6, the same parts as those in FIG. 5 are indicated by the same reference numerals and an explanation will be given, centering on the difference between FIG. 6 and FIG. 5. A case where the CMOS frequency converter of the third embodiment is used for up-conversion will be explained. The CMOS frequency converter may be used for down-conversion.

In the COMS frequency converter of FIG. 6, the input stage 110 voltage-current converts a differential input voltage signal IN into a differential input current signal Iin. The CMOS mixer 220 combines the differential input current signal Iin with a differential local oscillator signal LO, thereby generating a differential output current signal Iout. The amplifier stage 300 amplifies the differential output current signal Iout, thereby generating a differential output voltage signal OUT.

As shown in FIG. 6, the CMOS mixer 220, which is a passive double-balance CMOS mixer, includes CR circuits 221 and 222 each of whose signal paths is selected according to the signal frequency behind two switching transistor pairs MS31-MS32 and MS33-MS34, respectively. The switching transistor pairs MS31-MS32 and MS33-MS34 perform a complementary on/off operation repeatedly according to a differential LO signal supplied to the gates. Specifically, when MOS transistors MS31 and MS34 are on, MOS transistors MS32 and MS33 are off. When MOS transistors MS31 and MS34 are off, MOS transistors MS32 and MS33 are on. When MOS transistors MS31 and MS34 are on, the drain current of MOS transistor MS31 passes through the CR circuit 221 and is input as a positive-phase output current signal Iout+ to the amplifier stage 300 and the drain current of MOS transistor MS34 passes through the CR circuit 222 and is input as a negative-phase output current signal Iout− to the amplifier stage 300. When MOS transistors MS32 and MS33 are on, the drain current of MOS transistor MS33 passes through the CR circuit 222 and is input as a positive-phase output current signal Iout+ to the amplifier stage 300 and the drain current of MOS transistor MS32 passes through the CR circuit 221 and is input as a negative-phase output current signal Iout− to the amplifier stage 300.

Since the configuration of the CR circuit 222 is the same as that of the CR circuit 221, only the CR circuit 221 will be explained. In the explanation below, the CR circuit 222 will be understood by reading the reference numerals as the corresponding ones and the positive phase as the negative one.

The CR circuit 221 is a circuit where a parallel connection of a resistance R31 and a capacitor C31 and a parallel connection of a resistance R32 and a capacitor C32 are connected to MOS transistors M31 and M32, respectively. It is desirable that the resistance value of resistance R31 should be equal to that of resistance R32 and the capacitance of capacitor C31 should be equal to that of capacitor C32. In the explanation below, let the resistance value of each of the resistances R31 and R32 be R and the capacitance of each of the capacitors C31 and C32 be C.

The signal including the high-frequency signal components from the switching transistor pair MS31-MS32 and a noise signal including the low-frequency noise components from the input conversion noise source 302 of the amplifier stage 300 flow into the CR circuit 221. In the CR circuit 221, a signal path which passes through capacitor C31 and/or C32 is provided for the signal from the switching transistor pair M31-M32 and a signal path which passes through resistances R31 and R32 is provided for noise signal. Specifically, the impedance of the capacitors C31 and C32 constituting the CR circuit 221 is sufficiently lower than the resistance value R of the resistances R31 and R32 at the RF frequency. That is, since the output signal from the switching transistor pair MS31-MS32 has been up-converted using the differential LO signal, it passes through capacitor C31 and/or C32 and is input to the amplifier stage 300. In contrast, the frequency of the noise signal from the input conversion noise source 302 of the amplifier stage 300 is far lower than the RF frequency, which increases the impedance of the capacitors C31 and C32, with the result that the noise signal hardly passes. Accordingly, the noise signal from the input conversion noise source 302 mainly passes through the resistances R31 and R32.

Hereinafter, the operation of the CMOS mixer 220 of FIG. 6 will be explained, centering on the signal path of the output signal from the switching transistor pair and the noise signal from the input conversion noise source 302 in the amplifier stage 300.

The output signal from the switching transistor pair passes through the CR circuits 221 and 222, each of which outputs a differential output current signal Iout to the amplifying circuit 300. In the CR circuits 221 and 222, the path through which the output signal from switching transistor pair passes and its impedance will be explained, using the CR circuit 221 as an example.

Since the path through which the output signal from the switching transistor pair MS31-MS32 includes a parallel connection of a capacitor with the capacitance C and a resistance with the resistance value R, the impedance is expressed by the above-described equation (2). Actually, as described above, since the output signal from the switching transistor pair MS31-MS32 is a signal in the RF frequency band, it follows that 1+sCR≈sCR and therefore the impedance is approximated by 1/sC. Thus, the output signal from switching transistor pair MS31-MS32 hardly passes through the resistances R31 and R32 and most of the output signal passes through capacitor C31 and/or C32 and is input to the amplifier stage 300.

In the CMOS mixer 220, no element is inserted between the input stage 110 and the switching transistor pair MS31-MS32 and between the input stage 110 and the switching transistor pair MS33-MS34. The input impedance to each of the switching transistor pairs MS31-M32 and MS33-MS34 is sufficiently lower than the output impedance R20 of the current source 120. Therefore, a signal current shunt problem found in the related art does not arise, which allows most of the current generated by the current source 120 to be input as the differential input current signal Iin to the switching transistor pairs MS31-MS32 and MS33-MS34. That is, a decrease in the signal gain due to the signal current shunt is suppressed.

Furthermore, in the related art, large flicker noise was produced due to the imbalance between the impedance on the input stage side of the switching transistor pair and the impedance on the amplifier stage side. As described above, in the CMOS frequency converter of FIG. 6, since the impedance 1/sC on the input stage 100 side of the switching transistor pair MS41-MS42 is very low, the imbalance does not occur in the positive-phase input current signal Iin+, suppressing flicker noise.

When the switching transistor pair operates complementarily, a noise signal is not a problem. Therefore, a case where both the transistors of the switching transistor pair are turned on transiently will be explained, centering on the signal path in the CR circuit 221 for a noise signal.

In the CR circuit 221, a noise signal passes through a parallel connection of resistance R31 and capacitor C31 and then a parallel connection of resistance R32 and capacitor C32 by way of MOS transistors MS31 and MS32. Since the noise signal has a low frequency and the impedance of capacitor C25 increases, signal leakage to the input stage 110 side can be neglected. As described above, since the noise signal has a low frequency, the impedance of the capacitors C31 and C32 increases and becomes higher than the resistance R of the resistances R31 and R32. Therefore, in the CR circuit 221, the path passing through the resistances R31 and R32 is selected. That is, the noise signal hardly flows through the path passing through the capacitors C31 and C32 and mainly flows through the path passing through the resistances R31 and R32, causing the impedance of the path to be approximated by 2R.

Accordingly, if the resistance value of each of the on-resistances of MOS transistors MS31 and MS32 is Rs, a noise signal is input to an operational amplifier 301 with an input resistance whose resistance value is 2R+2Rs. That is, the noise gain of the amplifier stage 300 is Rf/(2R+2Rs). Generally, the resistance value Rs of the on-resistance is about several Ω, the resistance value Rf of each of the feedback elements 303 and 304 is about several kΩ, and the resistance value R of each of the resistances R31 and R32 is almost the same as the resistance value Rf. Therefore, the noise gain is not very large and is reduced remarkably as compared with the noise gain Rf/2Rs in the conventional example.

As described above, the CMOS frequency converter of the third embodiment is such that the CR circuit which selects a signal path passing through a capacitor for a signal including the high-frequency signal components from the switching transistor pair and a signal path passing through a resistance for a noise signal including the low-frequency noise components is provided behind the switching transistor pair in the CMOS mixer. Accordingly, in the CMOS frequency converter of the third embodiment, since the signal from the switching pair can pass through the CR circuit in a low impedance path, an increase in the flicker noise due to the imbalance between the impedances at the input and output of the switching transistor pair is suppressed. In addition, since no element is inserted between the switching transistor pair and the input stage, a decrease in the signal gain due to the current shunt in the input stage is suppressed. Moreover, when both the transistors of the switching transistor pair are turned on and a noise signal from the input conversion noise source in the amplifier stage passes through the CR circuit, since the path passing through the resistance is provided, the input resistance to the amplifier stage increases, which suppresses the noise gain.

### Fourth Embodiment

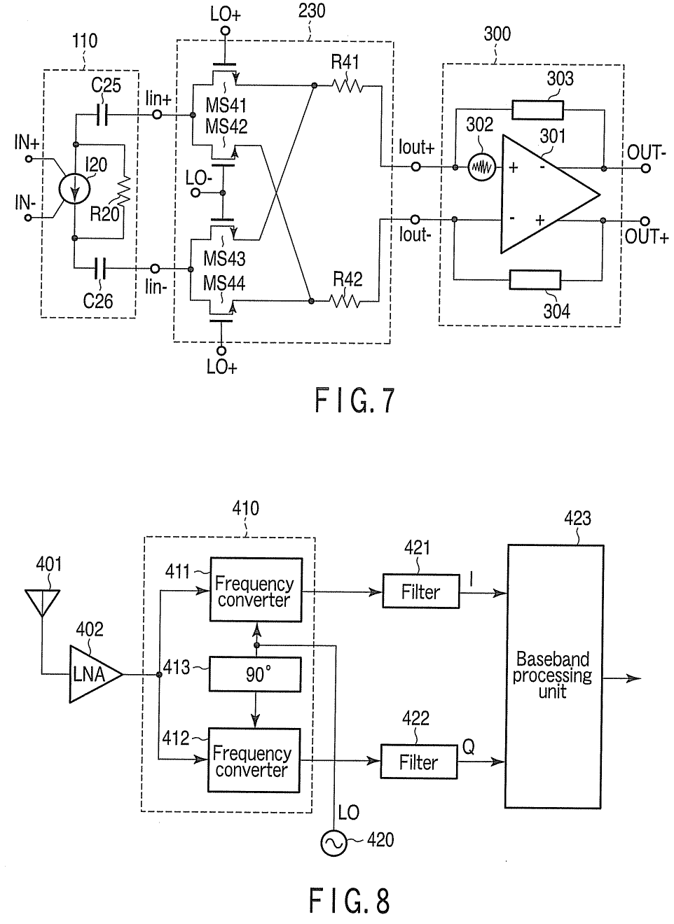

As shown in FIG. 7, a CMOS frequency converter according to a fourth embodiment of the invention is such that the CMOS mixer 220 is replaced with a CMOS mixer 230 in the CMOS frequency converter of FIG. 6. In FIG. 7, the same parts as those in FIG. 6 are indicated by the same reference numerals and an explanation will be given, centering on the difference between FIG. 7 and FIG. 6. A case where the CMOS frequency converter of the fourth embodiment is used for down-conversion will be explained. The CMOS frequency converter may be used for up-conversion.

In the COMS frequency converter of FIG. 7, the input stage 110 voltage-current converts a differential input voltage signal IN into a differential input current signal Iin. The CMOS mixer 230 combines the differential input current signal Iin with a differential local oscillator signal LO, thereby generating a differential output current signal Iout. The amplifier stage 300 amplifies the differential output current signal Iout, thereby generating a differential output voltage signal OUT.

As shown in FIG. 7, the CMOS mixer 230, which is a passive double-balance CMOS mixer, has resistances R41 and R42 inserted in front of output terminals. The switching transistor pairs MS41-MS42 and MS43-MS44 perform a complementary on/off operation repeatedly according to a differential LO signal supplied to the gates. Specifically, when MOS transistors MS41 and MS44 are on, MOS transistors MS42 and MS43 are off. When MOS transistors MS41 and MS44 are off, MOS transistors MS42 and MS43 are on. When MOS transistors MS41 and MS44 are on, the drain current of MOS transistor MS41 passes through resistance R41 and is input as a positive-phase output current signal Iout+ to the amplifier stage 300 and the drain current of MOS transistor MS44 passes through resistance R42 and is input as a negative-phase output current signal Iout− to the amplifier stage 300. When MOS transistors MS42 and MS43 are on, the drain current of MOS transistor MS43 passes through resistance R42 and is input as a positive-phase output current signal Iout+ to the amplifier stage 300 and the drain current of MOS transistor MS42 passes through resistance R41 and is input as a negative-phase output current signal Iout− to the amplifier stage 300.

Hereinafter, the operation of the CMOS mixer 230 of FIG. 7 will be explained, centering on the signal path of the noise signal from the input conversion noise source in the amplifier stage 300.

When the switching transistor pair operates complementarily, a noise signal is not a problem. Therefore, a case where both the transistors of the switching transistor pair are turned on transiently will be explained, centering on the signal path in the CMOS mixer 230 for a noise signal.

In the CMOS mixer 230, a noise signal passes through resistance R41 and branches into the switching transistor pair MS41-MS42 side and the switching transistor pair MS43-MS44 side. The branched noise signals pass through the switching transistor pair MS41-MS42 and the switching transistor pair MS43-MS44 respectively and flow into each other. The resulting signal passes through resistance R42 and is input to the amplifier stage 300.

Accordingly, if the resistance value of each of resistances R41 and R42 is R and the resistance value of the on-resistance of each of MOS transistors MS41 and MS42 is Rs, a noise signal is input to an operational amplifier 301 with an input resistance whose resistance value is 2R+2Rs. That is, the noise gain of the amplifier stage 300 is Rf/(2R+2Rs). Generally, the resistance value Rs of the on-resistance is about several Ω, the resistance value Rf of each of the feedback elements 303 and 304 is about several kΩ, and the resistance value R of each of resistances R41 and R42 is almost the same as the resistance value Rf. Therefore, the noise gain is not very large and is reduced remarkably as compared with the noise gain Rf/2Rs in the conventional example.

In the CMOS mixer 230, no element is inserted between the input stage 110 and the switching transistor pair MS41-MS42 and between the input stage 110 and the switching transistor pair MS43-MS44. The input impedance to each of the switching transistor pairs MS41-M42 and MS43-MS44 is sufficiently lower than the output impedance R20 of the current source 120. Therefore, a signal current shunt problem found in the related art does not arise, which allows most of the current generated by the current source 120 to be input as the differential input current signal Iin to the switching transistor pairs MS41-MS42 and MS43-MS44. That is, a decrease in the signal gain due to the signal current shunt is suppressed.

Furthermore, in the related art, large flicker noise was produced due to the imbalance between the impedance on the input stage side of the switching transistor pair and the impedance on the amplifier stage side. However, as described above, in the CMOS frequency converter of FIG. 7, since the impedance on the input stage 100 side of the switching transistor pair MS41-MS42 is very low, the imbalance does not occur in the positive-phase input current signal Iin+, suppressing flicker noise.

As described above, in the CMOS frequency converter of the fourth embodiment, resistances are provided in front of the output terminals of the CMOS mixer. Accordingly, with the CMOS frequency converter of the fourth embodiment, since no element is inserted between the switching transistor pair and the input stage, a decrease in the signal gain due to the current shunt in the input stage is suppressed. Moreover, when both the transistors of the switching transistor pair are turned on and a low-frequency noise signal from the input conversion noise source in the amplifier stage passes through the resistances, the input resistance to the amplifier stage increases, which suppresses the noise gain. Furthermore, the current input terminals of the differential switching transistor are short-circuited, which suppresses an increase in the flicker noise due to the imbalance between the impedances at the input and output of the switching transistor pair.

### Fifth Embodiment

As shown in FIG. 8, a receiver according to a fifth embodiment of the invention comprises an antenna 401, a low-noise amplifier (LNA) 402, an orthogonal demodulator 410, a local oscillator 420, filters 421, 422, and a baseband processing unit 423. The orthogonal demodulator 410 includes frequency converters 411, 412 according to any one of the first to fourth embodiments and a 90° phase shifter 413.

In the receiver of FIG. 8, an RF signal received by the antennal 401 is amplified by the LNA 402. The amplified signal is input to the orthogonal demodulator 410, which generates two orthogonal received baseband signals (I signal and Q signal). The generation of the I signal and Q signal will be described later. The filters 421 and 422 remove the high-frequency components from the received baseband signal. The resulting signal is processed by the baseband processing unit 423 including an analog-digital converter and a DSP (digital signal processor), thereby decoding and reproducing the original data signal.

The frequency converter 411 multiplies a received signal in an RF frequency band input to an IN terminal from the LNA 402 and a local oscillator signal input to an LO terminal from the local oscillator 420 together, thereby generating an I signal. The 90° phase shifter 413 shifts the local oscillator signal from the local oscillator 420 by 90° in phase. The frequency converter 412 multiplies the received signal in the RF frequency band input to the IN terminal from the LNA 402 and the local oscillator signal subjected to a 90° phase shift input to the LO terminal from the 90° phase shifter 413 together, thereby generating a Q signal.

As described above, the receiver of the fifth embodiment uses a frequency converter according to any one of the first to fourth embodiments to generate a received baseband signal by down-converting the received RF signal. Accordingly, with the receiver of the fifth embodiment, a high-gain, low-noise received baseband signal is obtained.

### Sixth Embodiment

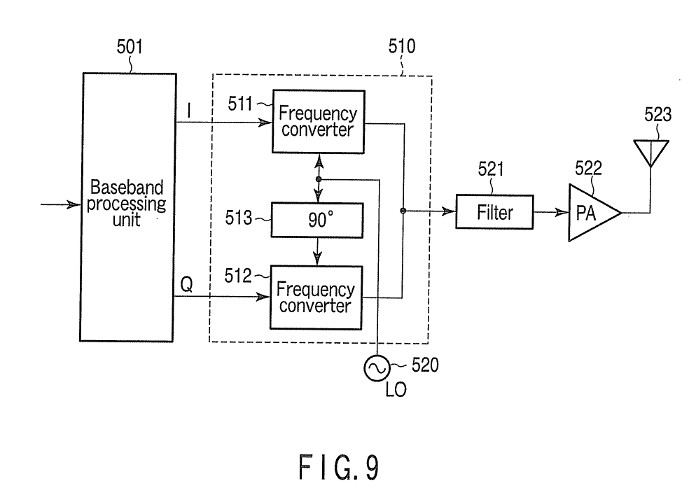

As shown in FIG. 9, a transmitter according to a sixth embodiment of the invention comprises a baseband processing unit 501, an orthogonal modulator 510, a local oscillator 520, a filter 521, a power amplifier (PA) 522, and an antenna 523. The orthogonal modulator 510 includes frequency converters 511, 512 according to any one of the first to fourth embodiments and a 90° phase shifter 513.

In the transmitter of FIG. 9, the baseband processing unit 501 generates a transmitting baseband signals (I signal and Q signal) according to a data signal to be transmitted. The orthogonal modulator 510 modulates the transmitting baseband signal orthogonally, thereby generating a transmitting RF signal. The filter 521 removes the low-frequency components from the transmitting RF signal. The resulting signal is amplified by the PA 522. The amplified signal is transmitted by the antenna 523.

The frequency converter 511 multiplies an I signal input to the IN terminal from the baseband processing unit 501 and the local oscillator signal input to the LO terminal from the local oscillator 520 together. The 90° phase shifter 513 shifts the local oscillator signal from the local oscillator 520 by 90° in phase. The frequency converter 512 multiplies the Q signal input to the IN terminal from the baseband processing unit 501 and the local oscillator signal subjected to a 90° phase shift input to the LO terminal from the 90° phase shifter 513 together. The output signal of the frequency converter 511 and that of the frequency converter 512 are combined, thereby generating a transmitting RF signal.

As described above, the transmitter of the sixth embodiment uses a frequency converter according to any one of the first to fourth embodiments to generate a transmitting RF signal by up-converting the transmitting baseband signal. Accordingly, with the transmitter of the sixth embodiment, a high-gain, low-noise transmitting RF signal is obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A frequency converter comprising:
a voltage-current converter circuit which converts a positive-phase input voltage signal and a negative-phase input voltage signal into a positive-phase input current signal and a negative-phase input current signal, respectively;
a switching circuit which switches between the positive-phase input current signal and the negative-phase input current signal according to a positive-phase local oscillator signal and a negative-phase local oscillator signal to generate a positive-phase output current signal and a negative-phase output current signal;
an amplifier circuit which current-voltage converts and amplifies the positive-phase output current signal and negative-phase output current signal to generate a positive-phase output voltage signal and a negative-phase output voltage signal; and
a plurality of CR circuits which are inserted at least either between the voltage-current converter circuit and the switching circuit or between the switching circuit and the amplifier circuit and each of which includes at least one capacitor through which high-frequency components pass and at least one resistance through which low-frequency noise components pass.

2. The frequency converter according to claim 1, wherein the impedance in a radio frequency band of the capacitor is lower than the on-resistance of a transistor in the switching circuit and the resistance value of the resistance in the CR circuit.

3. The frequency converter according to claim 1, wherein each of the CR circuits is inserted between the voltage-current converter circuit and the switching circuit and includes two capacitors to which the positive-phase input current signal or the negative-phase input current signal is input commonly and a resistance that connects the outputs of the two capacitors.

4. The frequency converter according to claim 1, wherein each of the CR circuits includes two parallel connections of a capacitor and a resistance which are inserted between the voltage-current converter circuit and the switching circuit and to which the positive-phase input current signal or the negative-phase input current signal is input commonly.

5. The frequency converter according to claim 1, wherein each of the CR circuits includes a parallel connection of a capacitor and a resistance to which the positive-phase output current signal is input and a parallel connection of a capacitor and a resistance to which the negative-phase output current signal is input, both the parallel connections being inserted between the switching circuit and the amplifier circuit.

6. A receiver comprising the frequency converter according to claim 1 which performs down-converting using the positive-phase local oscillator signal and the negative-phase local oscillator signal, with a received radio signal being used as the positive-phase input voltage signal and the negative-phase input voltage signal.

7. The frequency converter according to claim 1, wherein the voltage-current converter circuit includes a power supply;
a first MOS transistor which receives the positive-phase input voltage signal at its gate and outputs the positive-phase input current signal at its drain;
a second MOS transistor which receives the negative-phase input voltage signal at its gate and outputs the negative-phase input current signal at its drain;
resistances which are inserted between the power supply and the drains of the first MOS transistor and the second MOS transistor;
a current source which is connected commonly to the sources of the first MOS transistor and the second MOS transistor and which controls the sum of the drain currents of the first MOS transistor and the second MOS transistor; and
feedback inductors which are inserted between the sources of the first MOS transistor and the second MOS transistor and the current source.

8. The frequency converter according to claim 1, wherein the amplifier circuit includes
a power supply;
a first MOS transistor which receives the positive-phase output current signal at its gate and outputs the positive-phase output voltage signal at its drain;
a second MOS transistor which receives the negative-phase output current signal at its gate and outputs the negative-phase output voltage signal at its drain;
a load circuit which is inserted between the power supply and the drains of the first MOS transistor and the second MOS transistor;
a current source which is connected commonly to the sources of the first MOS transistor and the second MOS transistor and which controls the sum of the drain currents of the first MOS transistor and the second MOS transistor;
a first feedback element which connects the gate of the first MOS transistor and the drain of the second MOS transistor; and
a second feedback element which connects the gate of the second MOS transistor and the drain of the first MOS transistor.

9. A frequency converter comprising:
a voltage-current converter circuit which converts a positive-phase input voltage signal and a negative-phase input voltage signal into a positive-phase input current signal and a negative-phase input current signal, respectively;
a switching circuit which switches between the positive-phase input current signal and the negative-phase input current signal according to a positive-phase local oscillator signal and a negative-phase local oscillator signal to generate a positive-phase output current signal and a negative-phase output current signal;
an amplifier circuit which current-voltage converts and amplifies the positive-phase output current signal and negative-phase output current signal to generate a positive-phase output voltage signal and a negative-phase output voltage signal; and
two resistances which are provided in front of the amplifier circuit and through which the positive-phase output current signal or the negative-phase output current signal passes, respectively.

10. A receiver comprising the frequency converter according to claim 9 which performs down-converting using the positive-phase local oscillator signal and the negative-phase local oscillator signal, with a received radio signal being used as the positive-phase input voltage signal and the negative-phase input voltage signal.

11. The frequency converter according to claim 9, wherein the voltage-current converter circuit includes
a power supply;
a first MOS transistor which receives the positive-phase input voltage signal at its gate and outputs the positive-phase input current signal at its drain;
a second MOS transistor which receives the negative-phase input voltage signal at its gate and outputs the negative-phase input current signal at its drain;
resistances which are inserted between the power supply and the drains of the first MOS transistor and the second MOS transistor;
a current source which is connected commonly to the sources of the first MOS transistor and the second MOS transistor and which controls the sum of the drain currents of the first MOS transistor and the second MOS transistor; and
feedback inductors which are inserted between the sources of the first MOS transistor and the second MOS transistor and the current source.

12. The frequency converter according to claim 9, wherein the amplifier circuit includes
a power supply;
a first MOS transistor which receives the positive-phase output current signal at its gate and outputs the positive-phase output voltage signal at its drain;
a second MOS transistor which receives the negative-phase output current signal at its gate and outputs the negative-phase output voltage signal at its drain;
a load circuit which is inserted between the power supply and the drains of the first MOS transistor and the second MOS transistor;
a current source which is connected commonly to the sources of the first MOS transistor and the second MOS transistor and which controls the sum of the drain currents of the first MOS transistor and the second MOS transistor;
a first feedback element which connects the gate of the first MOS transistor and the drain of the second MOS transistor; and
a second feedback element which connects the gate of the second MOS transistor and the drain of the first MOS transistor.
